(19) United States
(12) Patent Application Publication
(10) Pub. No.: US 2015/0192461 A1
(43) Pub. Date: Jul. 9, 2015

(54) LIGHT MICROSCOPE AND METHOD OF CONTROLLING THE SAME

(71) Applicant: National University of Singapore, Singapore (SG)

(72) Inventor: Nanguang Chen, Singapore (SG)

(21) Appl. No.: 14/412,166

(22) PCT Filed: Jul. 5, 2013
(86) PCT No.: PCT/SG2013/000278

§ 371 Date: Dec. 30, 2014

Related U.S. Application Data
(60) Provisional application No. 61/668,084, filed on Jul. 5, 2012.

(51) Int. Cl. G01J 1/42; G01J 1/04; G02B 21/00

(52) U.S. Cl. CPC G01J 1/42; G02B 21/0052; G01J 1/0403; G01J 1/0411

(57) ABSTRACT

According to various embodiments, a light microscope is provided. The light microscope includes a scanning device for directing an illumination pattern onto a sample to be imaged, the scanning device being movable for shifting the illumination pattern to cover sections of the sample successively one after another, wherein for each section of the sample, the scanning device is configured to direct the illumination pattern onto the section for illuminating the section and to receive a return light from the section of the sample illuminated by the illumination pattern, a modulator arrangement configured to modulate a light intensity distribution of the illumination pattern within a focal plane on the sample corresponding to the section of the sample, as a function of time, and a detector arrangement for optically coupling the return light from each section to a detector, wherein the detector arrangement is configured to optically couple the respective return lights to respective portions of the detector successively for generating an image of the sample on the detector, wherein a respective portion of the detector corresponds to a respective section of the sample.

### CROSS-REFERENCE TO RELATED APPLICATION

This application claims the benefit of priority of US provisional application No. 61/668,084, filed 5 Jul. 2012, the content of it being hereby incorporated by reference in its entirety for all purposes.

### TECHNICAL FIELD

Various embodiments relate to a light microscope and a method of controlling the light microscope.

### BACKGROUND

Laser scanning confocal microscopy is an established-optical imaging method for biomedical applications and industrial inspection. It can provide optical sectioning, high contrast, depth resolved imaging, and diffraction limited spatial resolution. Usually, confocal microscopes rely on point-to-point scanning to form images. For two-dimensional imaging, two closely coupled galvanometers are generally employed to shift the illumination point inside the sample. While the maximal resonant frequency of most galvanometers is a few kilohertz, the image acquisition speed of confocal microscopes is typically less than a few frames per second for a standard image size of 512 by 512 pixels.

Some applications, however, require a much higher imaging speed. For example, optical imaging has been used to visualize intrinsic neuronal signals. In such a case, a millisecond temporal resolution (or around 1000 frame per second frame rate) is desirable. With point scanning confocal microscope, one has to compromise on spatial resolution, accept restricted scanning field of view or make trade-offs in sensitivity (low signal-to-noise ratio) to obtain microscopic evidence of fast cell processes.

The only way to overcome this problem is to illuminate multiple locations at the same time and to acquire the image in parallel. The result is an ideal combination of long pixel dwell times and short frame-acquisition time, resulting in fast frame rates and good sensitivity. This, for a long time, was the benefit of the classical confocal spinning disk systems—although this was combined with the inability to adjust the confocal aperture opening, the need to illuminate every location multiple times to avoid statistical inhomogeneities, and the need to synchronize with the frame charge-coupled device (CCD) readout. Such synchronization reduces the theoretical frame acquisition speed dramatically from, for example, 300 frames per second to typically 50 frames per second, which is not sufficient for certain physiological events, such as spike-rate analysis.

Line scan confocal microscopy provides an alternative approach for high scanning rate and high image quality. This may be achieved by the use of a line camera, and the parallel illumination and acquisition mode. Line scan confocal microscopes illuminate the sample along a line in the x direction, and scan this line in the y direction with a scan mirror. As line cameras permit readout speeds of up to 70,000 lines per second, a frame of 512 times 512 pixels can be acquired at 140 frames per second, with long pixel dwell times for high sensitivity.

FIG. 1 shows a schematic diagram of a conventional line-scan confocal system 100. The line-scan confocal system 100 includes a near-infrared (NIR) source 102 for providing an NIR light 104 which may pass through, in sequence, a collimator (CO) 106 with a focal length of 50 mm, a cylindrical lens (CL) 108 to condense the NIR light 104 in one dimension, a beam splitter (BS) 110, a slit 112, a spherical lens (L1) 114 with a focal length of 80 mm, an acousto-optic deflector (AOD) 116 to achieve mechanical vibration- and inertia-free scanning of the NIR light 104, a spherical lens (L2) 118 with a focal length of 60 mm, a spherical lens (L3) 120 with a focal length of 120 mm, a dichroic mirror (DM) 122, and an objective 124, to reach a sample 150.

Light from the sample 150 then passes back through, in sequence, the objective 124, DM 122, L3 120, L2 118, AOD 116, L1 114, the slit 112, BS 110 which then directs the light through a spherical lens (L4) 126 with a focal length of 60 mm, a spherical lens (L5) 128 with a focal length of 100 mm, and a filter 130 to a linear charge-coupled device (CCD) camera 132. The linear CCD camera 132 is a line camera which captures a one-dimensional image of the sample 150 on the same region of the CCD camera 132.

Line scan confocal microscopy relies on a slit aperture to reject out of focus light. The background rejection effectiveness of the slit, however, is inferior to that of a pinhole in a point scanning focal microscope. In addition, the available line cameras have a relatively high read-out noise level. Consequently, the signal to noise ratio and signal to background ratio achievable with a line scan confocal microscope are not good enough for imaging of thick biological tissues in vivo.

There is therefore a need for a light microscopy method with improved signal to noise ratio and improved signal to background rejection ratio.

### SUMMARY

According to an embodiment, a light microscope is provided. The light microscope may include a scanning device for directing an illumination pattern onto a sample to be imaged, the scanning device being movable for shifting the illumination pattern to cover sections of the sample successively one after another, wherein for each section of the sample, the scanning device is configured to direct the illumination pattern onto the section for illuminating the section and to receive a return light from the section of the sample illuminated by the illumination pattern, a modulator arrangement configured to modulate a light intensity distribution of the illumination pattern within a focal plane on the sample corresponding to the section of the sample, as a function of time, and a detector arrangement for optically coupling the return light from each section to a detector, wherein the detector arrangement is configured to optically couple the respective return lights to respective portions of the detector successively for generating an image of the sample on the detector, wherein a respective portion of the detector corresponds to a respective section of the sample.

According to an embodiment, a method of controlling a light microscope is provided. The method may include directing an illumination pattern onto a sample to be imaged, shifting the illumination pattern to cover sections of the sample successively one after another, wherein for each section of the sample, the illumination pattern is directed onto the section for illuminating the section and a return light is received from the section of the sample illuminated by the illumination pattern, modulating a light intensity distribution of the illumination pattern within a focal plane on the sample corresponding to the section of the sample, as a function of time, and optically coupling the respective return lights to respective portions of the detector successively for generating an image of the sample on the detector, wherein a respective portion of the detector corresponds to a respective section of the sample.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic diagram of a conventional line-scan confocal system.

FIG. 2A shows a schematic block diagram of a light microscope, according to various embodiments.

FIG. 2B shows a flow chart illustrating a method of controlling a light microscope, according to various embodiments.

FIG. 3 shows a schematic diagram of a light microscope, according to various embodiments.

FIG. 4 shows a schematic diagram of a light microscope, according to various embodiments.

FIG. 5 shows a schematic diagram of a modulator arrangement, according to various embodiments.

FIG. 6 shows a schematic front view of a spatial polarizer, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may relate to light microscopy, for example ultrafast light microscopy with optical sectioning capability or laser scanning microscopy with optical sectioning capability.

Various embodiments may provide a light microscope for ultra high speed acquisition of two-dimensional or three-dimensional optically sectioned images. The light microscope may illuminate a sample using or via a one-dimensional scanning device as an illumination scanner, which may create a scanning illumination pattern on the sample. The emission from the sample may be de-scanned by the same illumination scanner and passes through a detection aperture, which may match the illumination pattern. Another one-dimensional scanning device may be used as a detection scanner which may direct the emission photons passing through the detection aperture to a two-dimensional image sensor for image formation, corresponding to the sample being imaged.

Various embodiments may provide a design of light microscopy featuring a combination of ultrafast image acquisition (greater than 1,000 frames per second), excellent contrast and background rejection, and outstanding sensitivity, where its performance may not be matched by existing techniques.

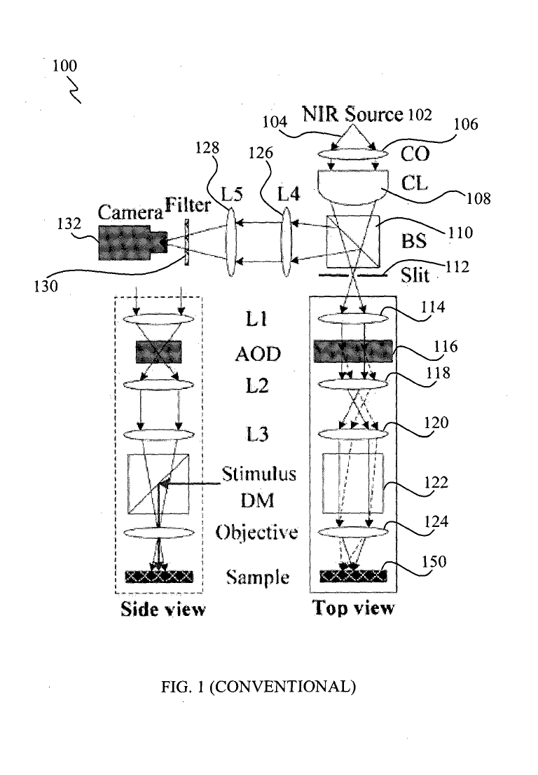

In contrast to conventional line scan confocal microscopy (e.g. FIG. 1) where the associated signal to noise ratio and signal to background ratio are not good enough for imaging of thick biological tissues in vivo, various embodiments may provide a high-speed light microscopy method with improved signal to noise ratio by the use of a two-dimensional image sensor, and improved signal to background rejection ratio by including focal modulation.

The light microscope of various embodiments may be used in various applications, including but not limited to, live cell imaging, small animal imaging, clinical diagnostics, and industrial inspection of samples.

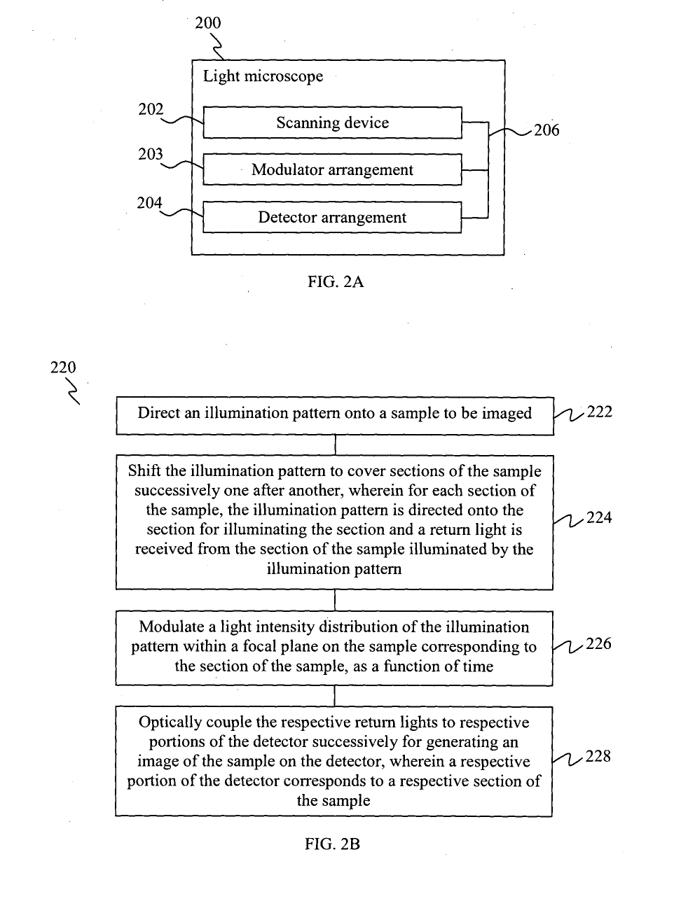

FIG. 2A shows a schematic block diagram of a light microscope 200, according to various embodiments. The light microscope 200 includes a scanning device 202 for directing an illumination pattern onto a sample to be imaged, the scanning device 202 being movable for shifting the illumination pattern to cover sections of the sample successively one after another, wherein for each section of the sample, the scanning device 202 is configured to direct the illumination pattern onto the section for illuminating the section and to receive a return light from the section of the sample illuminated by the illumination pattern, a modulator arrangement 203 configured to modulate a light intensity distribution of the illumination pattern within a focal plane on the sample corresponding to the section of the sample, as a function of time, and a detector arrangement 204 for optically coupling the return light from each section to a detector, wherein the detector arrangement 204 is configured to optically couple the respective return lights to respective portions of the detector successively for generating an image of the sample on the detector, wherein a respective portion of the detector corresponds to a respective section of the sample. The line represented as 206 is illustrated to show the relationship between the scanning device 202, the modulator arrangement 203 and the detector arrangement 204, which may include optical coupling and/or mechanical coupling.

In other words, the light microscope 200 may include a scanning device 202 which may direct an illumination pattern (e.g. light illumnation pattern) or optical signal onto a first section of a sample to illuminate the first section and to receive a first return light from the first section of the sample illuminated by the illumination pattern. A light intensity distribution of the illumination pattern provided within or on a focal plane on the sample corresponding to the section of the sample may be modulated, as a function of time (e.g. a periodic function of time), for example via a modulator arrangement 203. This may mean that the illumination pattern may be intensity modulated at around the focal region on the section of the sample. The light microscope 200 may further include a detector arrangement 204 which may receive the first return light so as to generate an image of the first section of the sample on a first portion of a detector.

Subsequently, the scanning device 202 may be moved so as to direct the illumination pattern, where its light intensity distribution may be modulated, onto a second section of the sample to illuminate the second section and to receive a second return light from the second section of the sample illuminated by the illumination pattern. The detector arrangement 204 may receive the second return light so as to generate an image of the second section of the sample on a second portion of the detector. This may be repeated for successive sections of the sample. By imaging section-by-section of the sample, e.g. the first section followed by the second section and so on, the light microscope 200 enables optical sectioning of the sample for imaging the sample one section at a time. In various embodiments, the light microscope 200 may be an ultrafast light microscopy with optical sectioning capability.

In various embodiments, the scanning device 202 may shift the illumination pattern to cover the entire field of view of the sample sequentially.

In various embodiments, the modulator arrangement 203 may selectively modulate the incident light intensity distribution of the illumination pattern within the focal plane of the sample as a periodic function of time, while ensuring that the excitation light intensity out of the focal plane may be at least substantially constant.

In various embodiments, the sequence in the order of the portions of the detector receiving the respective return lights may correspond to the sequence in the order of the sections of the sample being illuminated by the illumination pattern.

In various embodiments, the respective positions of the portions of the detector relative to each other may correspond to the respective positions of the sections of the sample relative to each other.

In the context of various embodiments, the illumination pattern directed onto a section of the sample and the corresponding return light may follow an at least substantially same optical or light path.

In the context of various embodiments, a return light may be induced from a section of the sample in response to the illumination of the section of the sample by the illumination pattern, for example by the illumination pattern where its light intensity distribution may be modulated within or on a focal plane on the sample corresponding to the section of the sample.

In the context of various embodiments, any one of or each of the respective return lights may include a portion of the illumination pattern light or excitation light reflected by the sample. In the context of various embodiments, any one of or each of the respective return lights may include fluorescence or fluorescent light emitted from the sample.

In the context of various embodiments, the scanning device 202 may be a movable mirror or reflector or light director for shifting the illumination pattern to cover sections of the sample successively one after another.

In the context of various embodiments, the scanning device 202 may be arranged in or along an illumination light path of the light microscope 200. The scanning device 202 may also be arranged in a part of a detection light path of the light microscope 200. The detector arrangement 204 may be arranged in or along the detection light path of the light microscope 200.

In the context of various embodiments, the detector arrangement 204 may be synchronized to a motion or scanning motion of the scanning device 202. As a non-limiting example, the motion of the scanning device 202 may be synchronized to a trigger signal (e.g. frame trigger) provided by the detector arrangement 204.

In various embodiments, the illumination pattern may include one or more of at least one of a spot, a pixel or a line. For example, the illumination pattern may include one or more of diffraction limited spots, or pixels, within a field of view of the sample. As a non-limiting example, where the illumination pattern includes a line, the scanning device 202 may perform line scanning of the sample, meaning that the sample may be scanned line-by-line, one line at a time. In various embodiments, the scanning device 202 may be a one-dimensional scanning device, for example which may direct light in one-dimensional form (e.g. line).

In various embodiments, the detector arrangement 204 may include the detector. The detector may be movable. This may mean that the detector may be moved such that respective portions of the detector may receive the respective return lights.

In various embodiments, a motion or scanning motion of the scanning device 202 may be synchronized with the detector. In various embodiments, movement of the detector may be synchronized to the motion of the scanning device 202. This may mean that the detector may be moved in sync with the motion of the scanning device 202. As a non-limiting example, the motion of the detector and the motion of the scanning device 202 may be synchronized to a trigger signal (e.g. frame trigger) provided by the detector.

In the context of various embodiments, the detector may be a two-dimensional (2D) detector, in contrast to a line detector or sensor which is a one-dimensional (1D) detector.

In the context of various embodiments, the detector may be an image sensor.

In the context of various embodiments, the detector may be or may include a camera capable of receiving the respective return lights on respective portions of the camera for generating a two-dimensional (2D) image of the sample. As non-limiting examples, the camera may be a charge-coupled device (CCD) camera or a complementary metal-oxide-semiconductor (CMOS) camera.

In various embodiments, the detector arrangement 204 may include another scanning device for receiving the respective return lights, the other scanning device being movable to direct the respective return lights onto the respective portions of the detector to generate the image of the sample. The respective return lights may be directed by this other scanning device onto the respective portions of the detector one after another.

In various embodiments, a motion or scanning motion of the other scanning device may be synchronized with the motion or scanning motion of the scanning device 202. This may mean that the scanning device 202 and the other scanning device may be moved in sync.

In various embodiments, the respective motions of the scanning device 202 and the other scanning device may be synchronized with the detector arrangement 204 or the detector. As a non-limiting example, the respective motions or scanning motions of the scanning device 202 and the other scanning device may be synchronized to a trigger signal (e.g. frame trigger) provided by the detector arrangement 204 or the detector.

In the context of various embodiments, the other scanning device may be a movable mirror or reflector or light director for directing the respective return lights onto the respective portions of the detector.

In various embodiments, the other scanning device may be configured for directing the respective return lights onto the respective portions of the detector line-by-line. In various embodiments, the other scanning device may be a one-dimensional scanning device, for example which may direct light in one-dimensional form (e.g. line).

In various embodiments, the light microscope 200 may be a scanner or double scanner line-scan microscope, e.g. a scanner or double scanner line-scan confocal microscope. In various embodiments, by providing the modulator arrangement 203 to modulate a light intensity distribution of the illumination pattern, the light microscope 200 may be a scanner or double scanner line-scan focal modulation microscope (FMM).

In various embodiments, the detector arrangement 204 may further include a detector lens for focusing the respective return lights onto the respective portions of the detector.

In various embodiments, the light microscope 200 may further include a detection aperture arranged between the scanning device 202 and the detector arrangement 204, for for rejecting at least some lights originating from parts of the sample free from illumination by the illumination pattern. This may mean that out-of-focus light from the sample that may be present in the respective return lights may be rejected or removed prior to reaching the detector arrangement 204. In various embodiments, the detection aperture may be or may include a slit.

In various embodiments, the light microscope 200 may further include a filter (e.g. emission filter) for filtering the respective return lights. This may remove any incident light reflected from the sample.

In various embodiments, the light microscope 200 may further include focusing optics (or focusing assembly) for directing and focusing the illumination pattern onto the focal plane on the sample corresponding to the section of the sample. This may mean that the focusing optics may focus the illumination pattern in a selected focal plane in the sample. The focusing optics may include at least one of a focusing lens, a collimating lens or an objective lens.

In various embodiments, the light microscope 200 may further include shaping optics for receiving a light and shaping the light into an array of incident light points (e.g. a point array) to provide the illumination pattern. In various embodiments, the array of incident light points may be arranged in a line. In various embodiments, the shaping optics may include a microlens array or diffractive devices. In various embodiments employing an array of incident light points, the detection aperture may include a plurality of openings corresponding to the array of incident light points.

In various embodiments, the light microscope 200 may further include shaping optics for receiving a light and shaping the light into a line-like form (or shape) to provide the illumination pattern. In various embodiments, the shaping optics may include a line-forming lens, e.g. a cylindrical lens.

In various embodiments, the light microscope 200 may further include an incident aperture arranged between the shaping optics and the scanning device 202. The incident aperture may be or may include a slit.

In various embodiments, the light microscope 200 may further include a lens arranged between the incident aperture and the scanning device 202 for providing the illumination pattern in collimated form.

In various embodiments, the light microscope 200 may further include a light director arranged between the scanning device 202 and the detector arrangement 204, for directing the respective return lights towards the detector arrangement 204. The light director may be a beam splitter or a dichroic mirror.

In the context of various embodiments, a beam splitter may mean an optical device which may split a beam of light in two, in the form of a reflected light and a transmitted light. The beam splitter may have any split ratio for the transmitted light to the reflected light, for example a transmitted light:reflected light ratio of between about 30:70 and about 70:30, for example about 30:70, about 40:60, about 50:50, about 60:40 or about 70:30.

In the context of various embodiments, a dichroic mirror may selectively pass light of a small range of colors (or wavelengths) while reflecting other colors.

In various embodiments, the modulator arrangement 203 may include a temporal phase modulator configured to receive a light and to decompose the light into two orthogonally polarized components and thereafter to introduce a phase difference between the two orthogonally polarized components (e.g. E_{X} and E_{Y}), and a spatial phase modulator optically coupled to the temporal phase modulator to receive the two orthogonally polarized components, the spatial phase modulator configured to spatially separate the two orthogonally polarized components and thereafter to convert the two orthogonally polarized components into one polarization state or direction. This means that the two orthogonally polarized components received by the spatial phase modulator have a phase difference between them.

In various embodiments, the phase difference may be introduced periodically between the two orthogonally polarized components, e.g. as a function of time. In various embodiments, the temporal phase modulator may be configured to introduce a variable phase shift (e.g. between 0 to π) on one of the two orthogonally polarized components. In various embodiments, the variable phase shift may be introduced on only one of the two orthogonally polarized components.

In various embodiments, the spatial phase modulator may convert the two orthogonally polarized components into a single polarization state.

In the context of various embodiments, the temporal phase modulator may include a half-wave plate configured to decompose the light into the two orthogonally polarized components, and an electro-optic modulator configured to introduce the phase difference between the two orthogonally polarized components.

In the context of various embodiments, a half-wave plate is an optical device that alters or shifts the polarization state or direction of a linearly polarized light.

In the context of various embodiments, an electro-optic modulator (EOM) is an optical device in which a signal-controlled element displaying electro-optic effect is used to modulate a beam of light, where the element may experience a change in its optical properties in response to an electric field due to the electro-optic effect.

In the context of various embodiments, the spatial phase modulator may include a spatial polarizer configured to spatially separate the two orthogonally polarized components, and a polarization analyser configured to convert the two orthogonally polarized components into the one polarization state.

In various embodiments, the spatial polarizer may include a first region or zone for selectively blocking one of the two orthogonally polarized components, and a second region or zone for selectively blocking the other of the two orthogonally polarized components. In various embodiments, the first region and the second region may be arranged adjacent side-by-side. In various embodiments, the first region may be arranged surrounding the second region. In various embodiments, the spatial polarizer may be divided in half to define the first region and the second region on respective halves of the spatial polarizer.

In various embodiments, the detector arrangement 204 may include a processor configured to generate respective optically sectioned images of the sample corresponding to the respective sections of the sample illuminated by the illumination pattern, wherein the processor is configured to demodulate the image (or raw image) generated by the detector for generating the respective optically sectioned images. In various embodiments, the processor may be configured to retrieve an amplitude of an AC component (e.g. modulated component) from each of the respective return lights. In various embodiments, the processor may include an image processing algorithm for generating an optically sectioned image of the sample by demodulating the raw image captured by the detector.

In various embodiments, the light microscope 200 may further include a light source assembly configured to provide a light for the illumination pattern. In various embodiments, the light from the light source may be provided directly as the illumination pattern, for example without modification.

In various embodiments, the light source may be configured to provide the illumination pattern in a line-like form or shape. The light source may be a slit-like light source to provide the illumination pattern in the line-like form.

In the context of various embodiments, the light source may be or may include one or more lasers. Therefore, in various embodiments, the light microscope 200 may be a laser scanning microscopy with optical sectioning capability.

In the context of various embodiments, the light used for the incident light may have a wavelength of between about 400 nm and about 700 nm, for example between about 400 nm and about 500 nm, between about 480 nm and about 700 nm, or between about 480 nm and about 550 nm.

In various embodiments, the detector arrangement 204 may be configured to optically couple a pixel of the respective section of the sample to a plurality of pixels in the respective portion of the detector. In various embodiments, the detector arrangement 204 may be configured for coupling the return light from each pixel in the field of view of the sample to a number of pixels in the detector in a sequential process, in which the incident light intensity in the illumination pattern may be varied for a few cycles.

In various embodiments, a number of pixels covered by the illumination pattern may at least substantially correspond (or close to) to a square root of a total number of pixels in a field of view of the sample to be imaged.

In the context of various embodiments, at least one of the scanning device 202 or the other scanning device may be a resonant scanner.

In the context of various embodiments, at least one of the scanning device 202 or the other scanning device may be a resonant galvanometer. The resonant galvanometer may include a mirror or other reflector to reflect light.

In the context of various embodiments, at least one of the scanning device 202 or the other scanning device may be an acousto-optic modulator (AOD). However, there may be challenges in employing AOD for scanning fluorescence light which may have a broad spectrum.

In the context of various embodiments, at least one of the scanning device 202 or the other scanning device may have an operating frequency between about a few Hz and about a few thousand Hz, for effecting scanning, for shifting the illumination pattern to cover sections of the sample successively one after another. As non-limiting examples, the operating frequency may be between about 1 Hz and about 10 kHz, e.g. between about 1 Hz and about 5 kHz, between about 1 Hz and about 1 kHz, between about 1 kHz and about 10 kHz, between about 5 kHz and about 10 kHz, or between about 2 kHz and about 5 kHz.

FIG. 2B shows a flow chart 220 illustrating a method of controlling a light microscope, according to various embodiments.

At 222, an illumination pattern is directed onto a sample to be imaged.

At 224, the illumination pattern is shifted to cover sections of the sample successively one after another, wherein for each section of the sample, the illumination pattern is directed onto the section for illuminating the section and a return light is received from the section of the sample illuminated by the illumination pattern.

At 226, a light intensity distribution of the illumination pattern within a focal plane on the sample corresponding to the section of the sample is modulated, as a function of time (e.g. a periodic function of time).

At 228, the respective return lights are optically coupled to respective portions of the detector successively for generating an image of the sample on the detector, wherein a respective portion of the detector corresponds to a respective section of the sample.

In various embodiments, the illumination pattern may include one or more of at least one of a spot, a pixel or a line. As a non-limiting example, in various embodiments, at 222, successive lines of the sample may be imaged one after another.

In various embodiments, a detector may be provided for detecting the respective return lights. The detector may be moved for detecting the respective return lights. In various embodiments, the detector may be a camera capable of receiving the respective return lights on respective portions of the camera for generating a two-dimensional image of the sample.

In various embodiments, at 222, the illumination pattern may be shifted using a scanning device, wherein a motion of the scanning device may be synchronized with the detector. The scanning device may be employed to direct the illumination pattern towards the section for illuminating the section and to receive a return light from the section of the sample illuminated by the illumination pattern. The scanning device may be movable.

In various embodiments, the respective return lights may be directed onto the respective portions of the detector to generate the image of the sample. For example, another scanning device may be used to direct the respective return lights onto the respective portions of the detector to generate the image of the sample. The other scanning device may be movable.

In various embodiments, the method may further include rejecting at least some lights originating from parts of the sample free from illumination by the illumination pattern.

In various embodiments, the respective return lights may be filtered, for example for removing any incident light reflected from the sample.

In various embodiments, the illumination pattern may be directed and focused towards the section of the sample for illuminating the section. This may be achieved, for example using focusing optics which may include at least one of a focusing lens, a collimating lens or an objective lens.

In various embodiments, a light may be received and shaped into an array of incident light points to provide the illumination pattern. This may be achieved, for example using shaping optics which may include a microlens array or diffractive devices.

In various embodiments, a light may be received and shaped into a line-like form to provide the illumination pattern. This may be achieved, for example using shaping optics which may include a line-forming lens, e.g. a cylindrical lens.

In various embodiments, respective return lights may be directed towards the detector arrangement with a light director. The light director may be a beam splitter or a dichroic mirror.

In various embodiments, for modulating a light intensity distribution of the illumination pattern, a light may be received and the light may be decomposed into two orthogonally polarized components and thereafter a phase difference may be introduced between the two orthogonally polarized components, and the two orthogonally polarized components may be spatially separated and thereafter the two orthogonally polarized components may be converted into one polarization state. The two orthogonally polarized components, to be spatially separated, may have a phase difference between them.

In various embodiments, for decomposing the light into two orthogonally polarized components and thereafter introducing a phase difference between the two orthogonally polarized components, a half-wave plate may be provided to decompose the light into the two orthogonally polarized components, and an electro-optic modulator may be provided to introduce the phase difference between the two orthogonally polarized components.

In various embodiments, for spatially separating the two orthogonally polarized components and thereafter converting the two orthogonally polarized components into one polarization state, a spatial polarizer may be provided to spatially separate the two orthogonally polarized components, and a polarization analyser may be provided to convert the two orthogonally polarized components into the one polarization state.

In various embodiments, for spatially separating the two orthogonally polarized components, one of the two orthogonally polarized components may be selectively blocked at a first region of the spatial polarizer, and the other of the two orthogonally polarized components may be selectively blocked at a second region of the spatial polarizer.

In various embodiments, the image (e.g. raw image) generated by the detector may be demodulated, for generating respective optically sectioned images of the sample corresponding to the respective sections of the sample illuminated by the illumination pattern In various embodiments, for demodulating the image, the method may include retrieving an amplitude of an AC component (e.g. modulated component) from each of the respective return lights.

In various embodiments, the method may further include providing a light for the illumination pattern. In various embodiments, one or more lasers may be provided to provide the light.

In various embodiments, at 228, a pixel of the respective section of the sample may be optically coupled to a plurality of pixels in the respective portion of the detector.

In various embodiments, a number of pixels covered by the illumination pattern at least substantially corresponds (or close to) to a square root of a total number of pixels in a field of view of the sample to be imaged.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

Various embodiments may provide a light microscope with a combination of improved imaging speed (greater than 1000 frames per second), outstanding image quality and exceptional sensitivity.

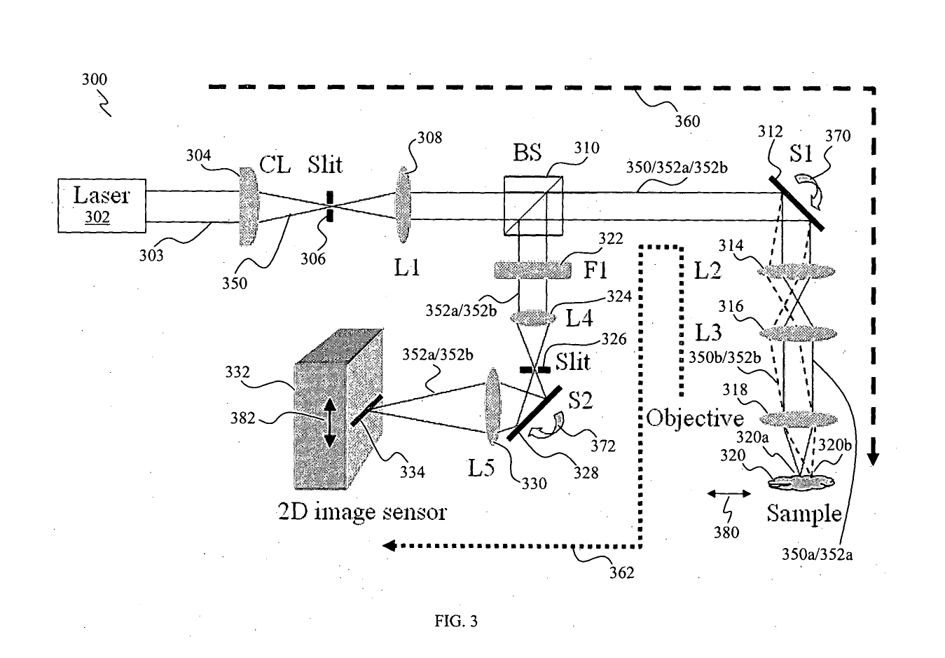

FIG. 3 shows a schematic diagram of a light microscope 300, according to various embodiments, illustrating a double scanner line-scan confocal microscope with a two-dimensional (2D) image sensor. The light microscope 300 may be an ultrafast line scan microscope.

The light microscope 300, for imaging a sample 320, may include a light source or light source assembly, for example in the form of a laser 302, which outputs an optical signal or light (e.g. wavelength, λ=488 nm) 303, which may act as an excitation beam. The light 303 passes through a cylindrical lens (CL) 304 which may condense the light 303 in one dimension, and which may focus the light 303 onto a line to provide an incident light, in the form of an illumination pattern 350, which may pass through an aperture, in the form of a slit 306. In other words, after transmitting through the cylindrical lens (CL) 304, the light 303 may be formed into an illumination pattern 350 having a line-like form, thereby providing an illumination line pattern for imaging the sample 320. The illumination line pattern 350 provided in the form of the incident light 350 may be transferred to the sample 320 via optics provided in or along an illumination light path, as represented by the dashed arrow 360, where the optics include a series of lenses.

A lens (L1) 308 may be arranged after the slit 306 to receive the illumination pattern 350 exiting from the slit 306, where the lens (L1) 308 may collimate the illumination pattern 350. The illumination pattern 350 may then pass through a beam splitter (BS) 310, which may transmit a certain amount of light of the illumination pattern 350 along the illumination light path 360. As a non-limiting example, the beam splitter (BS) 310 may have a 50:50 ratio in terms of the light reflected by the beam splitter (BS) 310 and the light transmitted by the beam splitter (BS) 310.

A scanning device or one-dimensional scanner (S1) 312, acting as an illumination scanner, may be provided along the illumination light path 360 after the beam splitter (BS) 310 to direct the illumination pattern 350 towards the sample 320. A pair of lenses, in the form of the lens (L2) 314 and the lens (L3) 316 may be provided to receive the illumination pattern 350 directed by the scanning device (S1) 312. The lens (L2) 314 may focus the illumination pattern 350, while the lens (L3) 316 may then collimate the illumination pattern 350. The illumination pattern 350 may then be received by an objective lens 318 for focusing the illumination pattern 350 onto the sample 320. At least one of the lens (L2) 314, the lens (L3) 316 or the objective lens 318 may form part of focusing optics or a focusing assembly. The focusing optics may direct and focus the illumination pattern 350 onto a focal plane corresponding to a section of the sample.

A return light originating from the sample 320 may follow an at least substantially similar light path as the illumination pattern 350, where the return light may pass through the objective lens 318, the lens (L3) 316, the lens (L2) 314 and received by the scanning device (S1) 312. In other words, the return light, which may include emission from the sample 320 may be de-scanned by the same illumination scanner (S1) 312. Therefore, the scanning device (S1) 312, the lens (L2) 314, the lens (L3) 316 and the objective lens 318 may also be arranged in or along a detection light path, as represented by the dotted arrow 362.

In various embodiments, the scanning device (S1) 312 may be employed to effect scanning of the sample 320, for shifting the illumination pattern 350 to cover sections of the sample successively one after another. For example, the scanning device (S1) 312 may be moved in a scanning motion as illustrated by the arrow 370. The scanning device (S1) 312 may be used to direct the illumination pattern 350 towards or onto a section of the sample 320, imposing the illumination line pattern onto this section of the sample 320 so as to illuminate this section, and thereafter receive the return light originating from this section of the sample 320. The scanning device (S1) 312 may then direct the illumination pattern 350 towards or onto another section of the sample 320, imposing the illumination line pattern onto this other section of the sample 320 so as to illuminate this other section, and thereafter receive the return light originating from this other section of the sample 320. This scanning process may be repeated such that the scanning device (S1) 312 may direct the illumination pattern 350 towards or onto successive or respective sections of the sample 320 for imaging the sample 320, and thereafter receive the respective return lights originating from the respective sections of the sample 320.

As a non-limiting example, the scanning device (S1) 312 may be used to shift the illumination pattern 350 in the orthogonal direction, as represented by the double-headed arrow 380. For example, the scanning device (S1) 312 may direct the illumination pattern, as represented by the solid line 350a, towards or onto a first section 320a of the sample 320 so as to illuminate the first section 320a, and thereafter receive the return light 352a originating from the first section 320a of the sample 320. The illumination pattern 350a and the return light 352a follow an at least substantially similar optical path.

The scanning device (S1) 312 may then be moved or tilted to direct the illumination pattern, as represented by the dashed line 350b, towards or onto a second section 320b of the sample 320 so as to illuminate the second section 320b, and thereafter receive the return light 352b originating from the second section 320b of the sample 320. The illumination pattern 350b and the return light 352b follow an at least substantially similar optical path.

The respective return lights 352a, 352b may be directed by the scanning device (S1) 312 towards the beam splitter (BS) 310 which may be arranged also in or along the detection light path 362. The beam splitter (BS) 310 may transmit a certain amount of the respective return light lights 352a, 352b along the detection light path 362 towards a detector, for example in the form of a two-dimensional (2D) image sensor 332. The image sensor 332 may be a charge-coupled device (CCD) camera or a complementary metal-oxide-semiconductor (CMOS) camera.

An optional emission filter (F1) 322 may be arranged in or along the detection light path 362 for suppressing the excitation light, for example part of the illumination pattern 350 which may be reflected from the sample 320 and directed by the scanning device (S1) 312 and the beam splitter (BS) 310 towards the image sensor 332. A lens (L4) 324 may be provided to focus the respective return lights 352a, 352b to pass through a detection aperture, in the form of a slit 326. The slit 326 may reject out-of-focus light, which may be present as part of the respective return lights 352a, 352b originating from the sample 320. The out-of-focus light may originate from parts of the sample free from illumination by the illumination pattern 350.

Another scanning device or one-dimensional scanner (S2) 328, acting as a detection scanner, may be provided to receive the respective return lights 352a, 352b, and to effect scanning of the respective return lights 352a, 352b onto the successive or respective portions of the image sensor 332 for generating the image of the sample 320. For example, the scanning device (S2) 328 may be moved in a scanning motion as illustrated by the arrow 372. A lens (e.g. detector lens) or lens system (L5) 330 may be provided to focus the respective return lights 352a, 352b, containing the emission photons originating from the sample 320, onto the image sensor 332. The line as represented by 334 indicates the linear distribution of the emission photons, which may be moved along the orthogonal direction, as represented by the double-headed arrow 382, by the use of the detection scanner (S2) 328. Additionally or alternatively, the image sensor 332 may be moved. The scanning device (S2) 328 and the image sensor 332 may form part of a detector arrangement.

As a non-limiting example, the scanning device (S2) 328 may direct the return light 352a from the first section 320a of the sample 320 onto a first portion of the image sensor 332, corresponding for example to the line 334. Subsequently, when the scanning device (S1) 312 has illuminated the second section 320b of the sample 320 and receive a return light therefrom, the scanning device (S2) 328 may be moved to direct the received return light 352b onto a second portion of the image sensor 332 along the direction 382, corresponding to the second section 320b of the sample 320. As a result, respective return lights from respective sections of the sample 320 may be directed onto respective portions of the image sensor, corresponding to the respective sections of the sample 320, for generating the image of the sample 320.

It should be appreciated that any one of or each of the lenses L1 308, L2 314, L3 316, L4 324 and L5 330 may be a spherical lens or an achromatic lens. The focal length of any one of or each of the lenses L1 308, L2 314, L3 316, L4 324 and L5 330 may be a few centimeters, for example between about 1 cm and about 10 cm, e.g. between about 1 cm and about 5 cm, between about 5 cm and about 10 cm, or between about 3 cm and about 6 cm.

In various embodiments, any one or each of the scanning device (S1) 312 and the scanning device (S2) 328 may be a resonant scanner, for example a resonant galvanometer having a mirror or other reflector to reflect light with a scanning effect. In various embodiments, scanning by any one of or each of the scanning device (S1) 312 and the scanning device (S2) 328 may be effected at a frequency of between about a few Hz and about a few thousand Hz, for example between about 1 Hz and about 10 kHz.

In various embodiments, the scanning devices (S1) 312, (S2) 328 may be synchronized with or to a trigger signal (e.g. frame trigger) of the image sensor 332. In various embodiments, a frame of a two-dimensional image may be directly formed in half (two way scanning) or one (one-way scanning) scanning period of the scanning device (S1) 312 and the scanning device (S2) 328. In various embodiments, using the scanning device (S1) 312 as an example, the scanning device (S1) 312 may be moved or rotated back and forth to scan the illumination pattern or excitation beam across the sample 320. In one-way scanning, signal or return light from the sample 320 may be collected when the illumination pattern or excitation beam is shifted, for example, from left to right, but not during the flyback (from right to left). In two way scanning, the signal or return light may be collected along or in both directions.

In various embodiments, the image sensor 332 may support a rate of over 5,000 frames per second (1024×1024 pixels), which may at least substantially match the speed of at least one of the scanning device (S1) 312 or the scanning device (S2) 328. Furthermore, the 2D image sensor 332 may be an ultralow noise level sensor, in contrast to a conventional 1D counterpart whose performance may be adversely affected by its noise level.

In various embodiments, it should be appreciated that the beam splitter (BS) 310 may be replaced by a dichroic mirror (DM) for fluorescence imaging.

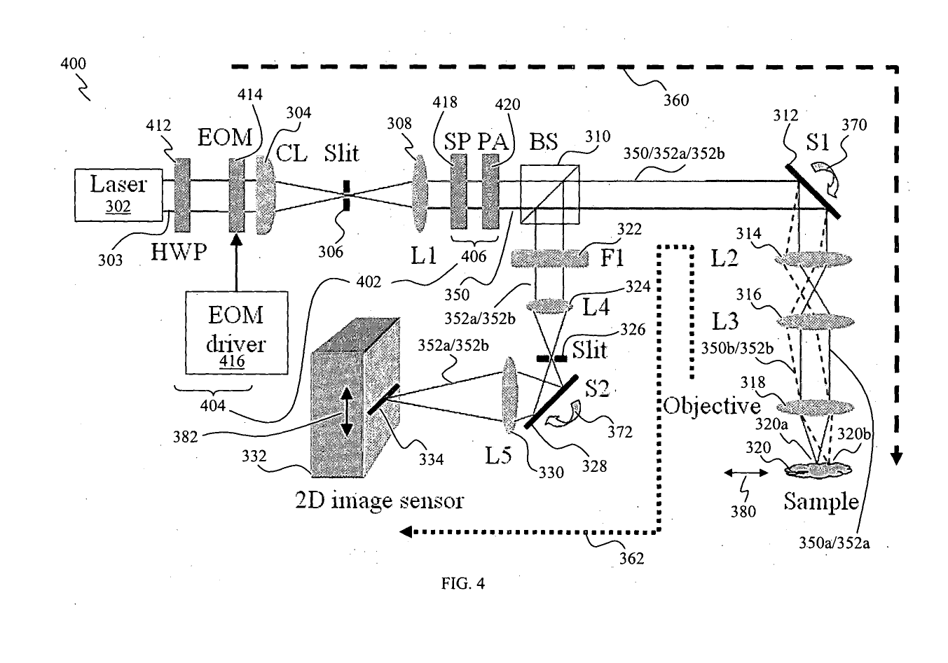

The setup as described in the context of the light microscope 300 of FIG. 3 may enable easy combination with focal modulation for enhanced background rejection, an example of which may be as illustrated in FIG. 4.

FIG. 4 shows a schematic diagram of a light microscope (e.g. a focal modulation light microscope) 400, according to various embodiments, illustrating a double scanner line-scan focal modulation microscope (FMM). The focal modulation line microscope 400 may include the same or like elements or components as those of the light microscope 300 of FIG. 3, and as such, the same numerals are assigned and the like elements may be as described in the context of the light microscope 300 of FIG. 3, and therefore the corresponding descriptions are omitted here.

For the light microscope 400, a spatial-temporal phase modulator (or modulator arrangement) 402 may be arranged in or along the excitation light path (illumination light path) 360 so that the excitation light may be intensity modulated around the focal line in or at the sample 320. In various embodiments, the spatial-temporal phase modulator 402 may modulate a light intensity distribution of the illumination pattern 350 within a focal plane on the sample corresponding to the section of the sample, as a periodic function of time. The spatial-temporal phase modulator 402 may include a temporal phase modulator 404 including a half-wave plate (HWP) 412 and an electro-optic modulator (EOM) 414. The electro-optic modulator (EOM) 414 may be driven by an EOM driver 416. The spatial-temporal phase modulator 402 may further include a spatial phase modulator 406 including a spatial modulator (SP) 418 and a polarization analyzer (PA) 420. The spatial modulator (SP) 418 and the polarization analyzer (PA) 420 may be arranged adjacent to each other. For the spatial-temporal phase modulator 402, two orthogonally polarized beams may be modulated differently by the temporal phase modulator 404. These two beams may be spatially overlapping before entering an aperture forming optics (e.g. which may comprise or consist of the spatial modulator (SP) 418 and the polarization analyzer (PA) 420) of the spatial phase modulator 406, after which the excitation beam may be spatial-temporally modulated with the desired properties.

A non-limiting example of the principle or operation of the spatial-temporal phase modulator 402 may be described with reference to FIG. 5, which illustrates an electro-optic modulator (EOM) based spatial-temporal phase modulator, including a single electro-optic modulator (EOM) and polarization optical components which may be as described above. For clarity purposes, the cylindrical lens (CL) 304, the slit 306 and the lens (L1) 308 are not shown in FIG. 5.

The laser output or light 303 from the laser 302 may be linearly polarized. The half-wave plate (HWP) 412 may be used to rotate the polarization of the electric field (E-field) of the light 303 to form approximately 45-degree angle with the Y-axis. For example, as shown in FIG. 5, the E-field 500 of the light 303, after having passed through the half-wave plate (HWP) 412 may be aligned at least substantially at 45° relative to the Y-axis 510 and the X-axis 512. As a result, the E-field 500 may be decomposed into two orthogonally polarized components, E_{Y} 502 and E_{X} 504, which may carry identical power.

The EOM 414 may be a polarization dependent device. The EOM 414 may provide a variable phase shift on E_{Y} 502 but substantially no phase shift on E_{X} 504. A modulation signal may be fed by the EOM driver 416 to the EOM 414 to introduce a periodic phase delay (e.g. between 0 to π) between E_{X} 504 and E_{Y} 502. As a result, a modulated E-field or beam, in the form of E_{Y} 502, and an unmodulated E-field or beam, in the form of E_{X} 504, may be provided.

Subsequently, the spatial polarizer 418 may selectively block E_{X} 504 or E_{Y} 502 so that the modulated and non-modulated beams may be spatially separated. For example, different regions or zones of the spatial polarizer 418 may be designated or defined to respectively selectively block either E_{X} 504 or E_{Y} 502.

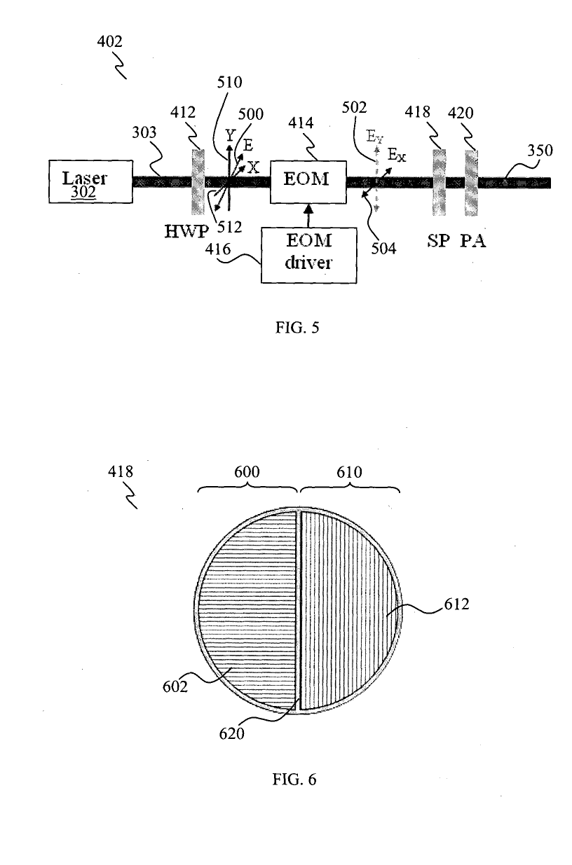

A non-limiting example of the spatial polarizer 418 may be as shown in FIG. 6, illustrating a two-zone spatial polarizer. The spatial polarizer 418 may be divided into two zones or regions: a first region (left region) 600 and a second region (right region) 610. The spatial polarizer 418 may be divided into two halves respectively defining the first region 600 and the second region 610.

The lines, as represented by 602 for the first region 600 and the lines, as represented by 612 for the second region 610, are illustrated to represent the respective polarization directions of the polarized light component that may be allowed to pass through. The spatial polarizer 418 may spatially separate two polarized light components, whose respective polarization directions are aligned orthogonally relative to each other, by selectively allowing a first polarized light component to pass through the first region 600 and selectively allowing another polarized light component to pass through the second region 610. For example, the spatial polarizer 418 may be arranged such that the lines 602 are aligned with the X-axis 512 (FIG. 5) to allow the horizontally polarized light, E_{X} 504, to pass through, while the lines 612 are aligned with the Y-axis 510 (FIG. 5) to allow the vertically polarized light, E_{Y} 502 to pass through. The line or boundary 620 separating the first region 600 and the second region 610 may be arranged in parallel to or aligned with the illumination slit 306.

Referring to FIG. 5, the polarization analyzer (PA) 420 may be a linear polarizer, where the polarization direction may be aligned at 45 degrees)(45° with the X-axis 512. The polarization analyzer (PA) 420 may be used to convert E_{X} 504 and E_{Y} 502 into the same polarization state or direction so that they may interfere with each other when brought to the focal point of the objective lens (e.g. 318, FIG. 4) on the sample 320. As a result, the intensity of the focal line may be periodically modulated.

Due to the focal modulation, a raw 2D image from the image sensor (e.g. 332, FIG. 4) may be spatially modulated along the scanning direction (e.g. 382, FIG. 4). The raw 2D image may be demodulated, for example by means of a processor, so as to generate respective optically sectioned images (e.g. in the form of FMM images) of the sample corresponding to the respective sections of the sample illuminated by the illumination pattern 350. For example, the raw 2D image may be separated into two images, respectively corresponding to maximal excitation power (e.g. when E_{X} 504 and E_{Y} 502 interfere at least substantially constructively) and minimal excitation power (e.g. when E_{X} 504 and E_{Y} 502 interfere at least substantially destructively) along the focal line. Most of the background, for example due to scattering and cross-talk, may be removed from the difference image between the two separated images.

In various embodiments, the FMM images may be formed by retrieving the amplitude of the ac component in the detected signal (e.g. return lights). This may mean that an FMM image may be formed by retrieving the amplitude (or intensity) of the modulated return light, which is the AC component. In order to generate an FMM line, an excitation line, due to the illumination pattern, may be formed in a section of the sample. At least two lines of emission signal or return light from the illuminated line region corresponding to the section of the sample may be collected, one when the focal intensity reaches the maximum and another at the minimum. The difference between the two lines results in a FMM line. Multiple FMM lines may be obtained successively or sequentially when the excitation line is scanned in the focal plane and combined to form a FMM image.

It should be appreciated that while the light microscopes 300 (FIG. 3), 400 (FIG. 4) have been described using an illumination pattern using lines, other illumination patterns, for example a point array (e.g. array of incident light points), may be used to replace the illumination line. The point array may be generated using a microlens array or diffractive devices. As a non-limiting example, the cylindrical lens 304 (FIGS. 3 and 4) may be replaced with a microlens array. In such embodiments using a point array as the illumination pattern, the detection slit 326 (FIGS. 3 and 4) may be replaced with an aperture that at least substantially matches the illumination pattern of the point array. For example, the slit 326 may be replaced with an aperture having a plurality of openings corresponding to the point array.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A light microscope comprising:
a scanning device for directing an illumination pattern onto a sample to be imaged, the scanning device being movable for shifting the illumination pattern to cover sections of the sample successively one after another, wherein for each section of the sample, the scanning device is configured to direct the illumination pattern onto the section for illuminating the section and to receive a return light from the section of the sample illuminated by the illumination pattern;
a modulator arrangement configured to modulate a light intensity distribution of the illumination pattern within a focal plane on the sample corresponding to the section of the sample, as a function of time; and
a detector arrangement for optically coupling the return light from each section to a detector, wherein the detector arrangement is configured to optically couple the respective return lights to respective portions of the detector successively for generating an image of the sample on the detector, wherein a respective portion of the detector corresponds to a respective section of the sample.

2. The light microscope as claimed in claim 1, wherein the illumination pattern comprises one or more of at least one of a spot, a pixel or a line.

3. The light microscope as claimed in claim 1, wherein the detector arrangement comprises the detector.

4. The light microscope as claimed in claim 3, wherein the detector is movable.

5. The light microscope as claimed in claim 3, wherein a motion of the scanning device is synchronized with the detector.

6. The light microscope as claimed in claim 3, wherein the detector comprises a camera capable of receiving the respective return lights on respective portions of the camera for generating a two-dimensional image of the sample.

7. The light microscope as claimed in claim 1, wherein the detector arrangement comprises another scanning device for receiving the respective return lights, the other scanning device being movable to direct the respective return lights onto the respective portions of the detector to generate the image of the sample.

8. The light microscope as claimed in claim 1, further comprising a detection aperture arranged between the scanning device and the detector arrangement, for rejecting at least some lights originating from parts of the sample free from illumination by the illumination pattern.

9. The light microscope as claimed in claim 1, further comprising a filter for filtering the respective return lights.

10. The light microscope as claimed in claim 1, further comprising focusing optics for directing and focusing the illumination pattern onto the focal plane on the sample corresponding to the section of the sample.

11. The light microscope as claimed in claim 1, further comprising shaping optics for receiving a light and shaping the light into an array of incident light points to provide the illumination pattern.

12. The light microscope as claimed in claim 1, further comprising shaping optics for receiving a light and shaping the light into a line-like form to provide the illumination pattern.

13. The light microscope as claimed in claim 1, further comprising a light director arranged between the scanning device and the detector arrangement, for directing the respective return lights towards the detector arrangement.

14. The light microscope as claimed in claim 1, wherein the modulator arrangement comprises:
a temporal phase modulator configured to receive a light and to decompose the light into two orthogonally polarized components and thereafter to introduce a phase difference between the two orthogonally polarized components; and
a spatial phase modulator optically coupled to the temporal phase modulator to receive the two orthogonally polarized components, the spatial phase modulator configured to spatially separate the two orthogonally polarized components and thereafter to convert the two orthogonally polarized components into one polarization state.

15. The light microscope as claimed in claim 14, wherein the temporal phase modulator comprises:
a half-wave plate configured to decompose the light into the two orthogonally polarized components; and
an electro-optic modulator configured to introduce the phase difference between the two orthogonally polarized components.

16. The light microscope as claimed in claim 14, wherein
the spatial phase modulator comprises:
a spatial polarizer configured to spatially separate the two orthogonally polarized components; and
a polarization analyzer configured to convert the two orthogonally polarized components into the one polarization state.

17. The light microscope as claimed in claim 16, wherein the spatial polarizer comprises:
a first region for selectively blocking one of the two orthogonally polarized components; and
a second region for selectively blocking the other of the two orthogonally polarized components.

18. The light microscope as claimed in claim 1, wherein the detector arrangement comprises a processor configured to generate respective optically sectioned images of the sample corresponding to the respective sections of the sample illuminated by the illumination pattern, wherein the processor is configured to demodulate the image generated by the detector for generating the respective optically sectioned images.

19. The light microscope as claimed in claim 18, wherein, for demodulating the image, the processor is configured to retrieve an amplitude of an AC component from each of the respective return lights.

20. The light microscope as claimed in claim 1, further comprising a light source assembly configured to provide a light for the illumination pattern.

21. The light microscope as claimed in claim 20, wherein the light source assembly comprises one or more lasers.

22. The light microscope as claimed in claim 1, wherein the detector arrangement is configured to optically couple a pixel of the respective section of the sample to a plurality of pixels in the respective portion of the detector.

23. The light microscope as claimed in claim 1, wherein a number of pixels covered by the illumination pattern at least substantially corresponds to a square root of a total number of pixels in a field of view of the sample to be imaged.

24. A method of controlling a light microscope, the method comprising:
directing an illumination pattern onto a sample to be imaged;
shifting the illumination pattern to cover sections of the sample successively one after another, wherein for each section of the sample, the illumination pattern is directed onto the section for illuminating the section and a return light is received from the section of the sample illuminated by the illumination pattern;
modulating a light intensity distribution of the illumination pattern within a focal plane on the sample corresponding to the section of the sample, as a function of time; and
optically coupling the respective return lights to respective portions of the detector successively for generating an image of the sample on the detector, wherein a respective portion of the detector corresponds to a respective section of the sample.

25-46. (canceled)
